(19) United States
(12) Patent Application Publication
(10) Pub. No.: US 2025/0335760 A1
(43) Pub. Date: Oct. 30, 2025

(54) ON-DEMAND MACHINE LEARNING MODEL OPTIMIZATION

(71) Applicant: Intuit, Inc., Mountain View, CA (US)

(72) Inventors: Amit KALAMKAR, Fremont, CA (US); Vigith MAURICE, Portland, OR (US)

(21) Appl. No.: 18/651,554

(22) Filed: Apr. 30, 2024

(51) Int. Cl. G06N 3/08

(52) U.S. Cl. CPC G06N 3/08

(57) ABSTRACT

Certain aspects of the disclosure pertain to on-demand machine learning model optimization. A machine learning model can be continuously monitored and analyzed to detect performance drift. The cause of any performance drift can be determined, and an appropriate response can be determined based on the cause or type of performance drift. A decision can be made regarding whether a prompt adjustment or fine-tuning is warranted to address the performance drift effectively. Prompt adjustment and fine-tuning can be performed on-demand and without halting or disrupting an inferencing process.

### BACKGROUND

### Field

Aspects of the subject disclosure relate to artificial intelligence and, more specifically, on-demand machine learning optimization.

### Description of Related Art

When new machine learning models are initially developed, entities may utilize A/B testing to select the best-performing models for production by splitting traffic between candidate models and comparing their outputs and metrics over time. However, as models continue processing real-world data, their performance gradually becomes stale or drifts from reality if not periodically updated since the data environment and customer needs may evolve in ways not reflected in the original training. To prevent this drift while avoiding resource-intensive retraining and associated downtime, models require periodic fine-tuning to adjust their parameters based on new data to reflect current conditions.

### SUMMARY

According to one aspect, machine learning model optimization comprises receiving output from the machine learning model returned in response to an input data stream, detecting a drift in the output quality over time, determining a type of the drift, determining an action to at least mitigate the drift and improve the output quality based on the type of the drift, and triggering performance of the action.

According to another aspect, a method of large language model (LLM) optimization comprises receiving output from the LLM generated in response to a sampled input stream of operational events, wherein the output of the LLM comprises a summary of log events after a rollback to a prior state; determining output quality based on comparison to output from another LLM model, detecting a drift in the output quality over time, determining a type of drift, and triggering performance of an action to at least mitigate the drift and improve output quality based on type.

Other aspects provide processing systems configured to perform the aforementioned methods as well as those described herein; non-transitory, computer-readable media comprising instructions that, when executed by a processor of a processing system, cause the processing system to perform the aforementioned methods as well as those described herein; a computer program product embodied on a computer-readable storage medium comprising code for performing the aforementioned methods as well as those further described herein; and a processing system comprising means for performing the aforementioned methods as well as those further described herein.

The following description and the related drawings set forth in detail certain illustrative features of one or more aspects of this disclosure.

### DESCRIPTION OF THE DRAWINGS

The appended figures depict certain aspects and are, therefore, not to be considered limiting of the scope of this disclosure.

FIG. 1 is a block diagram of a machine-learning-model management system.

FIG. 2 is a block diagram of an example evaluation component.

FIG. 3 is a block diagram of an example stream process component.

FIG. 4 is a flow chart diagram of an example method optimizing a machine learning model over time.

FIG. 5 is a flow chart diagram of another example method of optimizing machine learning model processing with data produced by another machine learning model.

FIG. 6 is a block diagram of an operating environment within which aspects of the subject disclosure can be performed.

To facilitate understanding, identical reference numerals have been used, where possible, to designate identical elements common to the drawings. It is contemplated that elements and features of one embodiment may be beneficially incorporated in other embodiments without further recitation.

### DETAILED DESCRIPTION

Aspects of the subject disclosure provide apparatuses, methods, processing systems, and computer-readable mediums for continuously evaluating a machine-learning model for drift and triggering a mitigation action to address detected drift.

A machine learning model is typically trained on a fixed data set during development. A trained model can then be deployed to perform inference tasks on previously unseen data. However, conventional technology associated with machine learning models has several technical problems. One problem is performance drift. Over time, a machine learning model's performance can degrade if the underlying data distribution changes or drifts since the machine learning model may no longer capture patterns and relationships in the current data. Traditionally, a machine learning model can be periodically fine-tuned on current data. However, between periods of fine-tuning, a machine learning model's performance can degrade as the data it is processing changes in character over time. Another problem is that fine-tuning a machine learning model is computationally expensive and can lead to downtime periods that are antithetical to low latency systems that operate on real-time data.

Aspects described herein provide technical solutions to at least the aforementioned technical problems. Machine learning models can be continuously monitored and analyzed to detect performance drift. The cause of any detected drift can be determined, such as changes in data schema or differences in model quality. An appropriate response can be determined based on the cause or type of drift. For instance, a decision can be made regarding whether prompt adjustments (e.g., changes in wording or addition of context) or fine-tuning are warranted to address the performance drift effectively. If a decision is made to adjust a prompt or fine-tune a model, adjusting a prompt or fine-tuning a model can be accomplished without halting or disrupting an inferencing process. An end-to-end on-demand solution is disclosed to detect issues, determine resolutions, and propagate changes seamlessly without human intervention and downtime periods for production systems.

Further aspects relate to custom machine learning models that are specifically trained or fine-tuned for particular domains, data types, or expected use cases. These custom machine learning models can exploit transfer learning and further training from a large industry-standard model, such as OpenAI®, using customized data sets. The fine-tuning process enables custom machine learning models to potentially outperform large, general models in their intended inference tasks, as they are tailored to specific data. By specializing machine learning models for real time inputs and tasks, technical benefits are achieved, including improved accuracy for specific use cases compared to general models and more efficient resource utilization due to smaller model size. Continuous evaluation and selection of machine learning models, including custom machine learning models, ensures that any degradation in model performance is promptly and automatically addressed to maintain high-quality inferences.

### Example Machine Learning Model Management System

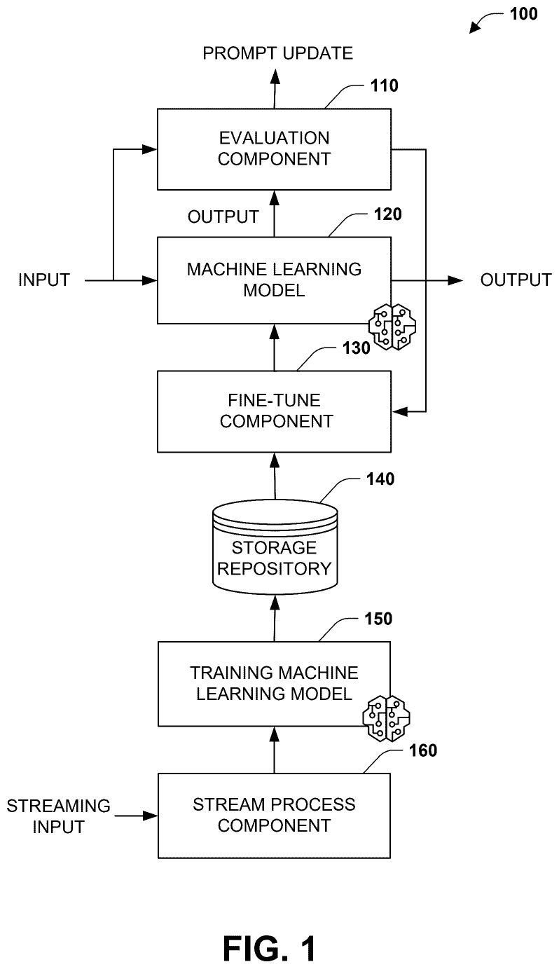

FIG. 1 depicts a high-level overview of an example implementation of a machine-learning-model management system that automatically detects and addresses performance drift of a machine learning model. The system 100 includes evaluation component 110, machine learning model 120, fine-tune component 130, storage repository 140, training machine learning model 150, and stream process component 160. The evaluation component 110, machine learning model 120, fine-tune component 130, training machine learning model 150, and stream process component 160 can be implemented by at least one processor coupled to at least one memory that stores instructions that, when executed by the at least one processor, cause the processor to perform the functionality of each component when executed. Consequently, a computing device can be configured as a special-purpose device or appliance that implements the functionality of the machine-learning-model management system 100. Further, all or portions of these components can be distributed across computing devices or made accessible through a network service.

The machine learning model 120 is trained on sample data to identify patterns and make data-driven predictions or inferences. In accordance with one embodiment, the machine learning model 120 can be developed for use in a production system. For instance, the machine learning model 120 can be trained on historical data to perform real-time decision-making or other tasks. According to one embodiment, the machine learning model 120 can correspond to a large language model (LLM). In one instance, the machine learning model 120 can correspond to a custom machine learning model tailored to a particular domain or set of tasks instead of a large and diverse data set on a wide range of domains and tasks. A custom machine learning model can be generated based on domain-specific training data, yielding a smaller model in terms of size and computational resources required to execute the model than a larger and more general machine learning model. In other words, a general machine learning model and a custom machine learning model serve different purposes. They are optimized for different use cases based on at least their scope (e.g., multiple domains versus a specific domain) and training data (e.g., publically available versus domain-specific (e.g., industry-specific, proprietary documents)).

In one embodiment, the machine learning model 120 can generate a summary of events and identify the root cause of a problem. For example, the machine learning model 120 can receive a stream of operational data, such as logs and events regarding application or container state and health status, for instance. In response to detection of a rollback of an application or system to a previous state, the machine learning model 120 can generate a text summary that seeks to identify the issue that caused the rollback based on the stream operational data. Optionally, a root cause can also be determined and provided as text. For example, a text explanation or summary can be “There are 676 information logs indicating that users were successfully logged in and requests were served successfully. The Kubernetes event shows that the container was terminated due to an OOMKilled.” The potential root cause can be “The container was terminated due to an out-of-memory (OOM) error, which may have caused the runtime error in the error log. Too many Redis connections opened may indicate an underlying issue with the connection that caused the runtime error.”

The evaluation component 110 is configured to monitor the performance of the machine learning model 120 continuously. For instance, the evaluation component 110 can track performance metrics like accuracy, latency, and user satisfaction (discussed further below) based on the model's current predictions, inferences, or outputs. Changes in performance metrics can be analyzed over time to detect meaningful divergence indicating a performance drift. Meaningful divergence refers to model performance metrics diverging over time in a significant manner rather than a minor fluctuation. Euclidean distance using clustering algorithms can be employed in one embodiment to distinguish between meaningful divergence and minor fluctuation, in which a larger distance corresponds to a higher divergence. A threshold distance can then be established that, when satisfied, indicates meaningful divergence. Additionally or alternatively, meaningful divergence can be determined based on labels from users after viewing results. For example, If performance drift is detected, the evaluation component 110 can also trigger a response to address the drift, for example, through prompt adjustments or fine-tuning the machine learning model 120. Prompt adjustment refers to modifying a textual prompt or instruction to provide context and guidance to the machine learning model 120. A prompt adjustment can be employed when the drift is minor or moderate in magnitude and impact. For example, prompt adjustment can be triggered if the machine learning model 120 deviates with respect to a comparison with another machine learning model, such as an industry standard model (e.g., OpenAI®), operating over the same input data. If the drift is significant, such as when there has been a change in the underlying data structure or schema, the evaluation component 110 can trigger fine-tuning of the machine learning model 120 by the fine-tune component 130. In accordance with one embodiment, schema evolution, which is a process of modifying a data structure schema, can be employed to determine drift from a source schema to data used to train previously. More automated and complex processes can also be employed. For example, column data can be analyzed utilizing natural language processing for a scenario where the schema remains the same, but the data has changed.

The fine-tune component 130 is configured to fine-tune or retrain the machine learning model 120. The fine-tune component 130 can acquire a new set of data that reflects changed data characteristics (e.g., new schema) and continue training the machine learning model 120 with the new data. The fine-tune component 130 can also validate the fine-tuned model on test data to check for drift resolution and acceptable performance. For example, a portion of a data set used to fine-tune the model can be set aside and utilized to evaluate performance, including whether the detected drift has been resolved. Alternatively, the fine-tuned model executes over live data, and a comparison can be made between the performance of the current model as a benchmark and the fine-tuned model's performance. In accordance with one embodiment, fine-tuning can be performed offline or outside an executing production system. The fine-tune component 130 can acquire training and testing data from the storage repository 140.

Further, fine-tuning can be performed without halting or disrupting inferencing. For example, inferencing and fine-tuning can be performed in parallel. In accordance with one embodiment, a copy of the machine learning model 120 can be generated and fine-tuned. In this manner, inference, or prediction, can be performed without downtime. Further, according to an embodiment, traffic can be routed to another machine learning model while the machine learning model 120 is fine-tuned offline. For example, a router component can accept side input, a communication mechanism that enables components to receive messages at runtime and potentially change runtime processing without halting or disrupting processing. Accordingly, before fine-tuning, a message can be sent to a router through side input communication to route input to another machine learning mode, such as a more expensive model in terms of required resources. The machine learning model 120 can then be decommissioned and subject to fine-tuning. After the machine learning model is fine-tuned, it can be recommissioned, and the router can be notified to route traffic to the machine learning model 120 once again, for example, if the recommissioned or new model outperforms other candidate models.

The storage repository 140 is a nonvolatile computer-readable storage device. In accordance with one embodiment, the storage repository 140 can correspond to a database within a database management system (DBMS). The DBMS can act as a centralized training data repository for on-demand fine-tuning. The storage repository 140 can include a variety of characteristics including scalable storage for holding large volumes of historical and streaming training data and metadata tracking to store metadata describing the data such as schema, features, and collection period. The storage repository 140 can also enable programmatic access to data to receive, transform, and ingest data.

The training machine learning model 150 is another model that can operate over input data and generate a response or make a prediction. According to one embodiment, the training machine learning model 150 can correspond to a general off-the-shelf language model such as OpenAI®. While not specialized for any particular domain or task, the training machine learning model 150 provides a broad baseline level of knowledge learned from vast sources (e.g., publically available data and websites). The input and output of the training model can be saved to the storage repository for use in fine-tuning the machine learning model 120. According to one embodiment, the training machine learning model 150 is a seed model, which refers to an existing pre-trained model used to develop a customized model by building upon what the seed model previously learned. The input data set can be used to fine-tune the machine learning model 120 through transfer learning. Over time, the customized model may surpass a more general training machine learning model 150 in terms of performance through fine-tuning. Transfer learning can involve exploiting knowledge of a seed model to fine-tune a different model. Transfer learning can occur even without access to the parameters of a seed model by fine-tuning based on the output of the seed model given input data. In other words, utilizing output from a seed model as training data can transfer the knowledge of the seed model to the model being fine-tuned. For example, a large language model can be fine-tuned to relearn layers based on custom data.

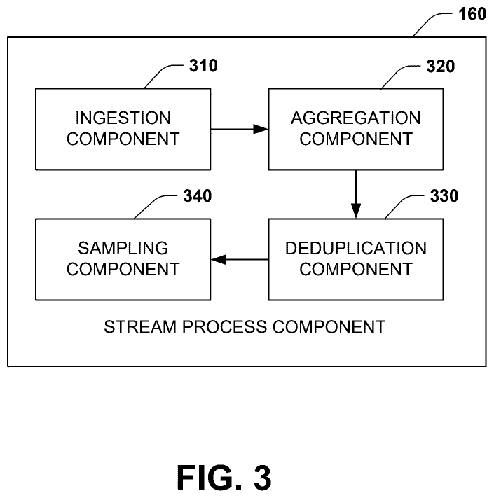

The stream process component 160 is configured to transform received streaming input before providing the input to the training machine learning model 150. In accordance with one embodiment, the streaming input can correspond to the same or a superset of the input provided to the machine learning model 120. Further, the streaming input can correspond to two or more data streams that can be aggregated into a single unified stream that can further be processed, for example, to remove duplicates. Further details are provided below regarding an example stream process component 160 in FIG. 3. Aggregating multiple streams into a single unified stream can utilize computational resources more efficiently than processing multiple streams independently, as it reduces overhead associated with managing multiple connections, buffers, and processing pipelines. Further, such aggregation supports real-time analysis and decision-making for situations that require timeliness.

The machine-learning-model management system 100 enables model performance improvement over time. The evaluation component 110 continuously monitors model performance to detect drift. In one instance, the fine-tune component 130 adjusts a model on-demand, or when needed, based on training data produced by the training machine learning model 150. Further, inference traffic can be routed to a different machine learning model while fine-tuning is performed in parallel with inferencing. The model management system 100 can thus automatically detect issues, determine resolutions, and propagate changes. More specifically, the machine-learning-model management system 100 can promptly detect model performance drift with continuous monitoring that avoids ridged schedules and associated delays between scheduled periods. Further, fine-tuning of a machine learning model can be triggered to address the detected drift in a manner that does not lead to inferencing downtime or disruption,

### Example Evaluation Component

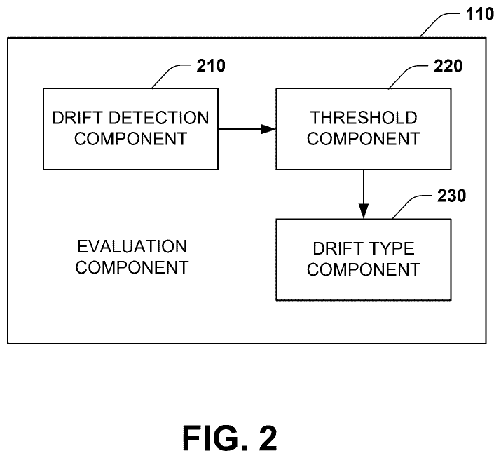

FIG. 2 is a block diagram of an example evaluation component 110. The example evaluation component 110 includes several subcomponents: drift detection component 210, threshold component 220, and drift type component 230. These subcomponents can also be implemented by at least one processor coupled to at least one memory that stores instructions that, when executed by the at least one processor, cause the processor to perform the functionality of each component when executed.

The drift detection component 210 is configured to monitor the performance of a machine learning model continuously to detect the occurrence of performance drift. The drift detection component 210 can track performance metrics such as accuracy, latency, and user satisfaction based on output predictions or inferences from a machine learning model, for example, on real time data. In accordance with one embodiment, accuracy can be determined based on a benchmark machine learning model that serves as a reference point against which performance can be evaluated. The drift detection component 210 can analyze changes in the performance metric over measurement periods to identify trends rather than isolated fluctuations. In one embodiment, the drift detection component 210 can compare the performance metrics to the performance metrics of another machine learning model operating on the same input. In this manner, the drift detection component 210 can seek to pinpoint when the machine learning model's performance begins to meaningfully diverge from another model. An industry standard model, often referred to as a benchmark model, is selected based on its established performance and widespread acceptance within the industry or domain. The benchmark model serves as a reference point against which the performance of other models can be evaluated.

Threshold component 220 can be configured with acceptable thresholds for metric divergence based on configured criteria. The threshold component 220 can compare changes in performance metrics to aid in determining whether or not to initiate further action, for example, to address the performance change. In one instance, the threshold can also establish what constitutes meaningful divergence. By way of example, a 1-10 range can be utilized, where greater than three is a warning, and greater than six is critical. Accordingly, the threshold can be greater than six to indicate meaningful divergence.

The drift type component 230 is configured to determine a type of drift related to the cause of a performance drift. For example, the drift type can be output or data. Output drift refers to differences in model quality that are unrelated to data. Output drift can occur even when the model and input data are the same due to changes in environment or context (e.g., user behavior, user preferences, external factors), software updates, and hardware variability, among other things. Data drift refers to changes in data or schema that are not reflected in previous training. Output drift is less significant than data drift because fine tuning or retraining a machine-learning model is unnecessary to address output drift. Although not limited thereto, for a promptable model, such as an LLM, a prompt can be adjusted to reduce or eliminate the output drift in one instance. For example, an original prompt can be “Give me the last 30 days rolling average of web performance for an asset ‘X’,” and an adjusted prompt can be “If data is in the format YYYYMMDD, then give me the last 30 days rolling average of web performance for an asset ‘X’” to aid in generating a correct timestamp comparator. Accordingly, the drift type can be inferred based on the drift extent. In other words, the determination can be based on whether performance drifted significantly or slightly, which can be measured by comparison to one or more thresholds. Additionally or alternatively, the drift type component 230 can perform root cause analysis to determine or infer the cause of a performance drift based on examining model outputs, errors, and other diagnostic metrics and logs. For example, schema evolution can be detected and inferred to cause data drift. Alternatively, a user's input and output responses can be analyzed to determine output drift. Further, a user can be notified of a potential output drift in one embodiment, and the user can confirm or reject the presence of output drift. Regardless of implementation, once a drift type is determined, one or more corresponding actions can be triggered to remedy the drift. For instance, a prompt engineer can add or adjust a prompt to address an output drift. Fine-tuning or retraining can be triggered to address a data drift.

### Example Stream Process Component

FIG. 3 is a block diagram of an example stream process component 160. The example stream process component 160 includes several subcomponents: ingestion component 310, aggregation component 320, deduplication component 330, and sampling component 340. These subcomponents can also be implemented by at least one processor coupled to at least one memory that stores instructions that, when executed by the at least one processor, cause the processor to perform the functionality of each component when executed.

The ingestion component 310 is configured to receive event streams from various sources and prepare data from the event streams for further processing. In accordance with one embodiment, the ingestion component 310 can include connectors that interface with different stream sources, such as applications, Kubernetes®, and metric systems, to pull in raw event data. The ingestion component 310 can also employ buffering mechanisms (e.g., Apache Kafka®) to reliably store and manage high volumes of incoming events in a distributed and scalable manner. Further, the ingestion component 310 can provide initial parsing logic to extract fields like timestamps and identifiers from event payloads and represent them in a uniform format or schema. Additionally, initial data filtering can be performed to remove invalid or incomplete data that does not meet basic formatting, structure requirements, or other requirements. Furthermore, received data can be pushed to an outbound stream to be consumed by downstream processing components, such as the aggregation component 320.

The aggregation component 320 can receive event streams and aggregate event payloads based on the contextual metadata. For example, data can be grouped based on an entity associated with the data (e.g., application, container). In one instance, data can be aggregated after a predetermined time, such as “N” minutes. In other words, data can be grouped based on a given time period in which events occur such that a continuous stream of events can be processed. The aggregation component 320 can combine data from multiple streams into a single unified stream. Aggregation allows different but related data elements (e.g., events, logs, health status, container state) to be evaluated together by a machine learning model. Such consolidation and joint analysis improve performance efficiency over separate data analysis as it reduces overhead associated with managing multiple connections, buffers, and processing pipelines. Further, aggregation supports responsiveness for real-time analysis and decision.

The deduplication component 330 is configured to identify and remove duplicate or redundant data in a stream, such as the unified stream. Deduplication reduces computational overhead by eliminating duplicate data and provides a cleaner input for machine learning models by removing noise from repetitive data.

The sampling component 340 is configured to select a subset of streaming data received as input and output samples for processing by a machine learning model. For example, consider a software health monitoring that seeks to identify anomalous behavior based on continuously produced metrics like CPU and memory utilization. All CPU and memory usage metrics need not be processed. Rather, a representative sample can be utilized. Various sampling strategies can be employed including random, stratified, systematic, and cluster sampling, among others. More specifically, the sampling component 340 receives aggregated and deduplicated streaming data from a unified stream. The sampling component 340 can apply a sampling frequency to select a portion of the data. The sampling component 340 improves processing efficiency by selecting a representative sample of data rather than all the data, reducing computational overhead. Further, the sampling component 340 aids continuous evaluation based on live data without disrupting streaming and inference. The sampling component 340 can also accept side input, for example, to adjust the sampling frequency.

### Example Methods of Optimizing Machine Learning Models

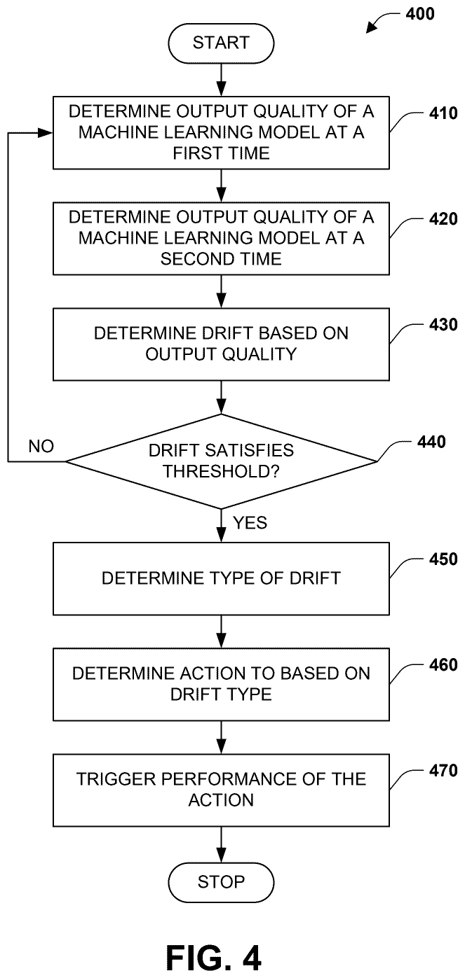

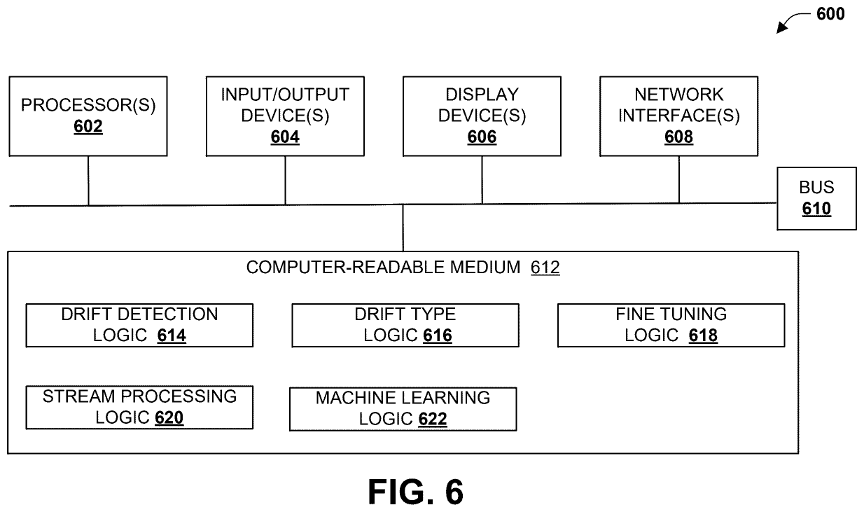

FIG. 4 depicts an example method 400 of optimizing machine learning model processing over time. In one aspect, method 400 can be implemented by the machine-learning- model management system 100 of FIG. 1 and the processing apparatus of FIG. 6.

Method 400 starts at block 410 with determining the output quality of a machine learning model for a first time. The output quality can be captured by one or more performance metrics, such as accuracy, latency, and user satisfaction. Accordingly, the output quality can be determined by obtaining the performance metrics for a first time.

The method 400 proceeds to block 420 with determining the output quality of a machine learning model for a second time. Similar to block 410, the method 400 can obtain one or more performance metrics, such as accuracy, latency, and user satisfaction for a second time. In this instance, the second time is a configurable period of time later than the first time.

The method 400 continues to block 430 with determining a drift based on the output quality. In other words, there is a difference in the performance metrics for the first time and the second time. More specifically, the performance metrics can indicate worse performance the second time and better performance the first time.

The method 400 proceeds to block 440, with determining whether the drift satisfies a threshold. According to one embodiment, the threshold can be a numeric value that can aid in determining whether there is a meaningful performance divergence over time or a minor performance fluctuation. If the drift does not satisfy the threshold (“NO”), the method 400 returns to block 410 to determine the output quality at another time. If the drift satisfies the threshold (“YES”), the method 400 moves to block 450.

At block 450, the method 400 proceeds with determining the type of drift. A type of drift relates to the cause of a performance drift. For example, the drift type can be output or data. Output drift refers to differences in model quality unrelated to data, and data drift refers to changes in data or schema that are not reflected in previous training. Output drift is less significant than data drift because fine tuning or retraining a machine-learning model is unnecessary to address output drift. A prompt can be added or adjusted to reduce or eliminate the output drift in one instance. Accordingly, the drift type can be inferred based on the drift extent. In other words, the determination can be based on whether performance drifted significantly or slightly, which can be measured by comparison to one or more thresholds. Additionally or alternatively, root cause analysis can be performed to determine or infer the cause of a performance drift based on examining model outputs, errors, and other diagnostic metrics and logs.

The method 400 next continues to block 460, with determining an action based on the drift type. In accordance with one embodiment, the action can correspond to adding or adjusting an input prompt for an output drift. Further, the action can correspond to fine-tuning or retraining a machine learning model for data drift.

The method 400 proceeds to block 470, with triggering performance of the determined action. In one instance, triggering the action can correspond to requesting a prompt engineer add or adjust an input prompt. In another instance, triggering the action can correspond to initiating fine-tuning or retraining the machine learning model. In either instance, data can be routed to another machine learning model, such as OpenAI®, while a custom machine learning model, for example, is being updated by prompt or fine-tuning. The switch can be accomplished with a routing component that supports side input, which can receive and implement the request at runtime without halting or disrupting processing.

The ability to automatically identify when a machine learning model begins to drift and remedy the drift, for example, through on-demand fine-tuning, provides key technical benefits. First, such aspects ensure optimal model accuracy is continuously maintained to prevent performance degradation that impacts customers over time as data evolves. Addressing drift through targeted updates avoids expensive full retraining cycles that can cause disruptive downtime periods prohibited in modern low-latency systems. Propagating changes seamlessly with zero blackout periods also optimizes availability and responsiveness. Further, continuous monitoring of models to detect and remedy drift issues provides an efficient, automated processes that avoids rigid schedules and delays in incorporating updates. Dynamically detecting individual model changes also optimizes computing resource utilization for maximum scalability as data volumes increase long-term.

Note that FIG. 4 is just one example of a method, and other methods including fewer, additional, or alternative steps are possible consistent with this disclosure.

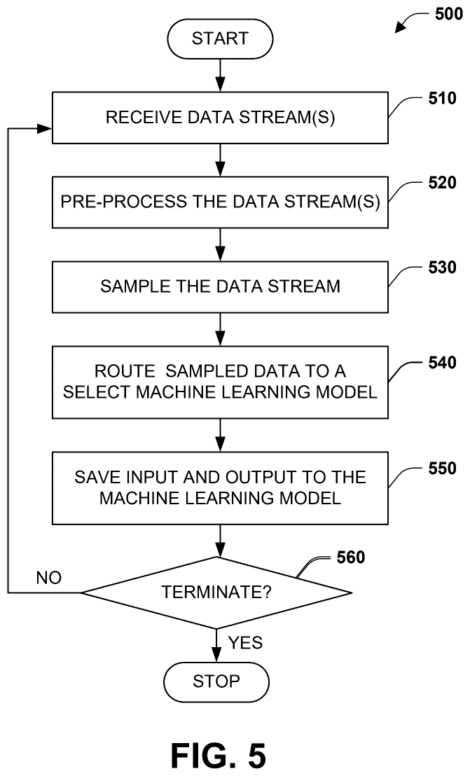

FIG. 5 depicts an example method 500 of optimizing machine learning model processing based on data produced by another machine learning model. In one aspect, method 400 can be implemented by the machine-learning-model management system 100 of FIG. 1 and the processing apparatus of FIG. 6.

The method 500 starts at block 510, with receiving one or more data streams. A data stream is a continuous real-time flow of information from a source. In accordance with one embodiment, the data stream can comprise operational data, such as logs and events regarding application or container state and health status, for instance. In some instances, particular data can be provided in separate data streams from separate sources, such as Kubernetes or metric systems.

The method 500 then proceeds to block 520, with preprocessing the one or more data streams received at block 510. In accordance with one embodiment, preprocessing can include aggregation and deduplication. With respect to aggregation, data from multiple streams can be combined into a single unified stream. For example, operational data from different streams can be combined into a single data stream comprising operational data from the different streams. As per deduplication, duplicate or redundant data in a stream, such as the unified stream, can be identified and removed. For instance, if the unified stream of operational data includes duplicate events, one of the events can be removed. Preprocessing data is not limited to aggregation and deduplication. Other preprocess operations can include but are not limited to data cleaning (e.g., providing missing values, addressing inconsistencies), anonymization (e.g., removing identity attributes for privacy), and filtering (e.g., removing unrelated data to focus on a particular domain). At a high level, preprocessing prepares streaming data for efficient machine learning model evaluation and selection.

Method 500 continues next to block 530 with sampling the data stream. Sampling comprises selecting a subset of streaming data. More specifically, sampling can comprise receiving aggregated streaming data from a unified stream and selecting a portion of the data from the unified stream based on a sampling frequency. The sampling frequency refers to the rate at which a portion of incoming streaming data is selected. In other words, sampling frequency captures the percentage or number of data elements selected from the full set. Sampling improves process efficiency by selecting a representative sample of data rather than all the data, reducing computational overhead.

Method 500 proceeds to block 540, with routing sampled data to a training machine learning model. In accordance with one embodiment, a general large language mode such as OpenAI® can correspond to the training machine learning model. While not specialized for any particular domain or task, the training machine learning model provides a broad baseline level of knowledge learned from vast sources.

The method 500 continues to block 550, with saving the training model's input and output to a storage repository, such as a database. Subsequently, the input and output can be utilized as training data to fine-tune or retrain a custom machine learning model. According to one embodiment, the training machine learning model is a seed model, and the stored data can be used to fine-tune the machine learning model through transfer learning. Over time, the custom machine learning model may surpass the general training machine learning model in terms of performance through fine-tuning.

Next, the method 500 proceeds to block 560, with determining whether to terminate the method 500. In accordance with one embodiment, the method 500 can run continuously to capture data changes and enable fine tuning of a custom machine learning model. However, the method may need to stop for maintenance, update, upgrade, or other reasons. If it is determined that the method is not to terminate (“NO”), the method 500 loops back to block 510 to receive more input data. If it is determined that the method is to terminate (“YES”), the method 500 stops.

The method 500 exploits a pre-trained model, such as OpenAI®, as a training machine learning model to generate data that provides technical benefits when fine-tuning models. The training machine learning model can enable automatic collection of vast amounts of data derived from its broad pre-training. The data can be programmatically processed and stored in a centralized repository to support on-demand access during fine-tuning workflows. Having a curated dataset that builds upon a model's inherent knowledge acts as an informed starting point, seeding the fine-tuning process more efficiently than random initialization. It enables new models to develop specialized skills through transfer learning while retaining grounding from large language corpora. This seeded approach circumvents costly full retraining cycles and helps produce long-term models that maintain high accuracy as domains and tasks evolve.

Note that FIG. 5 is just one example of a method, and other methods including fewer, additional, or alternative steps are possible consistent with this disclosure.

### Example Processing System for Machine Learning Model Management

FIG. 6 depicts an example processing system 600 configured to perform various aspects described herein, including, for example, methods as described above with respect to FIGS. 4 and 5.

Processing system 600 is generally an example of an electronic device configured to execute computer-executable instructions, such as those derived from compiled or interpreted computer code, including without limitation personal computers, tablet computers, servers, smart phones, smart devices, wearable devices, augmented or virtual reality devices, and others.

In the depicted example, processing system 600 includes one or more processors 602, one or more input/output devices 604, one or more display devices 606, and one or more network interfaces 608 through which processing system 600 is connected to one or more networks (e.g., a local network, an intranet, the Internet, or any other group of processing systems communicatively connected to each other), and computer-readable medium 612.

In the depicted example, the aforementioned components are coupled by a bus 610, which may generally be configured for data or power exchange amongst the components. Bus 610 may be representative of multiple buses, while only one is depicted for simplicity.

Processor(s) 602 are generally configured to retrieve and execute instructions stored in one or more memories, including local memories like the computer-readable medium 612, as well as remote memories and data stores. Similarly, processor(s) 602 are configured to retrieve and store application data residing in local memories like the computer-readable medium 612, as well as remote memories and data stores. More generally, bus 610 is configured to transmit programming instructions and application data among the processor(s) 602, display device(s) 606, network interface(s) 608, and computer-readable medium 612. In certain embodiments, processor(s) 602 are included to be representative of one or more central processing units (CPUs), graphics processing units (GPUs), tensor processing units (TPUs), accelerators, and other processing devices.

Input/output device(s) 604 may include any device, mechanism, system, interactive display, or various other hardware components for communicating information between processing system 600 and a user of processing system 600. For example, input/output device(s) 604 may include input hardware, such as a keyboard, touch screen, button, microphone, or other device for receiving inputs from the user. Input/output device(s) 604 may further include display hardware, such as, for example, a monitor, a video card, or other device for sending or presenting visual data to the user. In certain embodiments, input/output device(s) 604 is or includes a graphical user interface.

Display device(s) 606 may generally include any device configured to display data, information, graphics, user interface elements, and the like to a user. For example, display device(s) 606 may include internal and external displays, such as an internal display of a tablet computer or an external display for a server computer or a projector. Display device(s) 606 may further include displays for devices, such as augmented, virtual, or extended reality devices.

Network interface(s) 608 provide processing system 600 access to external networks and processing systems. Network interface(s) 608 can generally be any device capable of transmitting or receiving data through a wired or wireless network connection. Accordingly, network interface(s) 608 can include a transceiver for sending or receiving wired or wireless communication. For example, Network interface(s) 608 may include an antenna, a modem, a LAN port, a Wi-Fi card, a WiMAX card, cellular communications hardware, near-field communication (NFC) hardware, satellite communication hardware, or any wired or wireless hardware for communicating with other networks or devices/systems. In certain embodiments, network interface(s) 608 includes hardware configured to operate in accordance with the Bluetooth® wireless communication protocol.

Computer-readable medium 612 may be a volatile memory, such as a random access memory (RAM), or a nonvolatile memory, such as nonvolatile random access memory, phase change random access memory, or the like. In this example, computer-readable medium 612 includes drift detection logic 614, drift type logic 616, fine-tuning logic 618, stream processing logic 620, and machine learning logic 622.

In certain embodiments, the drift detection logic 614 can monitor a machine learning model and detect a performance drift over time. The drift detection component 210 of FIG. 2 can perform the drift detection logic 614.

In certain embodiments, drift type logic 616 can determine the type of performance drift that can correspond to the cause of the drift. The drift type logic 616 can be performed by the drift type component 230 of FIG. 2.

In certain embodiments, fine-tuning logic 618 can train a pre-trained machine learning model on a specific task or domain to optimize model performance. The fine-tuning logic 618 can be performed by the fine-tune component 130 of FIG. 1.

In certain embodiments, stream processing logic 620 transforms incoming real time data streams before providing the data to a machine learning model. The stream process component 160 of FIG. 1 can perform the stream processing logic 620.

In certain embodiments, machine learning logic 622 identifies patterns to make data-driven predictions or inferences on unseen input data. The machine learning model 120 and training machine learning model 150 of FIG. 1 can perform the machine learning logic 622.

Note that FIG. 6 is just one example of a processing system consistent with aspects described herein, and other processing systems having additional, alternative, or fewer components are possible consistent with this disclosure.

### Example Clauses

Implementation examples are described in the following numbered clauses:

Clause 1: A method of machine learning model optimization, comprising: receiving output from the machine learning model returned in response to an input data stream, determining output quality of the machine learning model, detecting a drift in the output quality over time, determining a type of the drift, determining an action to at least mitigate the drift and improve the output quality based on the type of the drift, and triggering performance of the action.

Clause 2: The method of Clause 1, further comprising determining the type of the drift to be a data drift resulting from a change in dataset structure.

Clause 3: The method of Clauses 1-2, further comprising determining the action to be fine-tuning and triggering the fine-tuning of the machine learning model to adapt to the change in the dataset structure.

Clause 4: The method of Clauses 1-3, further comprising determining the type to be an output drift, wherein the output of the machine learning model deviates relative to another machine learning model operating on the input data stream.

Clause 5: The method of Clauses 1-4, further comprising determining the action to be adding an input prompt and triggering generation and addition of the input prompt to user input to the machine learning model.

Clause 6: The method of Clauses 1-5, wherein the input data stream comprises sampled operational data regarding a deployed application.

Clause 7: The method of Clauses 1-6, wherein the machine learning model is a large language model (LLM) that outputs a text summarization of log events.

Clause 8: The method of Clauses 1-7, wherein the machine learning model is a large language model (LLM) and the output is a root cause of a rollback to a prior state.

Clause 9: A processing system, comprising: a memory comprising computer- executable instructions and a processor configured to execute the computer-executable instructions and cause the processing system to perform a method in accordance with any one of Clauses 1-8.

Clause 10: A processing system, comprising means for performing a method in accordance with any one of Clauses 1-8.

Clause 11: A non-transitory computer-readable medium storing program code for causing a processing system to perform the steps of any one of Clauses 1-8.

Clause 12: A computer program product embodied on a computer-readable storage medium comprising code for performing a method in accordance with any one of Clauses 1-8.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various elements, steps, or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules, method steps, and flow components described in the present disclosure may be implemented or performed with a general-purpose processor, a special-purpose processor (e.g., an artificial intelligence processor), combinations of general-purpose and special-purpose processors, and other programmable logic devices, or any combination thereof. A general-purpose processor may be a microprocessor, a commercially available processor, a controller, a microcontroller, or a state machine. A processor may also be implemented as a combination of computing devices.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same clement (e.g., a-a, a-a-a, a-a-b, a-a-c, a-b-b, a c c, b-b, b-b-b, b-b-c, c-c, and c-c-c or any other ordering of a, b, and c).

As used herein, “real time” refers to processing with minimal and acceptable delay. The term emphasizes immediacy while recognizing that some level of latency exists in any system. The term practically targets a time frame imperceptible to a user or within the requirements of a particular application without requiring instantaneous or zero latency responses.

Throughout this disclosure, the discussion focused on fine-tuning a machine learning model to mitigate or resolve performance drift or adding or adjusting prompts. In accordance with one embodiment, a machine-learning model can be trained or retrained from scratch using the same data used to fine-tune a currently existing model. Training a new model requires more time than fine-tuning a model, which is why fine-tuning is often preferred. However, this disclosure also applies to training a new model.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory), and the like. Also, “determining” may include resolving, selecting, choosing, establishing, and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as one or more buses.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to general and special-purpose processors.

The following claims are not intended to be limited to the aspects shown herein, but are to be accorded the full scope consistent with the language of the claims. Reference to an clement in the singular is not intended to mean only one element unless specifically so stated, but rather “one or more” elements. The subsequent use of a definite article (e.g., “the” or “said”) with respect to an element (e.g., “the processor”) is not intended to limit the claim to an interpretation requiring only a single element (e.g., “only one processor”) unless otherwise specifically stated. For example, reference to an element (e.g., “a processor,” “a controller,” “a memory,” “the processor,” “the controller,” “the memory,”), unless otherwise specifically stated, should be understood to refer to one or more elements (e.g., “one or more processors,” “one or more controllers,” “one or more memories,”).

The terms “set” and “group” in the claims are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., a system, a processing system, or an apparatus) to perform functions, one element may be configured to cause the other element to perform all functions, or more than one element may collectively be configured to cause the other element to perform the functions.

Unless specifically stated otherwise, the term “some” refers to one or more.

All structural and functional equivalents to the elements of the various aspects described throughout this disclosure that are known or later become known to those of ordinary skill in the art are intended to be encompassed by the claims. Moreover, nothing disclosed herein is intended to be dedicated to the public, regardless of whether such disclosure is explicitly recited in the claims.

What is claimed is:

1. A method of machine learning model optimization, comprising:
receiving output from a machine learning model returned in response to an input data stream;
determining output quality of the machine learning model;
detecting a drift in the output quality over time;
determining a type of the drift;
determining an action to at least mitigate the drift and improve the output quality based on the type of the drift; and
triggering performance of the action.

2. The method of claim 1, further comprising determining the type of the drift to be a data drift resulting from a change in dataset structure.

3. The method of claim 2, further comprising:
determining the action to be fine-tuning; and
triggering the fine-tuning of the machine learning model to adapt to the change in the dataset structure.

4. The method of claim 1, further comprising determining the type to be an output drift, wherein the output of the machine learning model deviates relative to another machine learning model operating on the input data stream.

5. The method of claim 4, further comprising:
determining the action to be adding an input prompt; and
triggering generation and addition of the input prompt to user input to the machine learning model.

6. The method of claim 1, wherein the input data stream comprises sampled operational data regarding a deployed application.

7. The method of claim 6, wherein the machine learning model is a large language model (LLM) that outputs a text summarization of log events.

8. The method of claim 1, wherein the machine learning model is a large language model (LLM) and the output is a root cause of a rollback to a prior state.

9. A system for machine learning model optimization, comprising:
at least one processor; and
at least one memory coupled to the at least one processor that stores instructions, that when executed by the at least one processor, cause the system to:
receive output from a machine learning model generated in response to an input data stream;
determine output quality;
detect a drift in the output quality;
determine a type of the drift;
determine an action to at least mitigate the drift and improve the output quality based on the type of the drift; and
trigger performance of the action.

10. The system of claim 9, wherein the type is a data drift resulting from a change in dataset structure.

11. The system of claim 10, wherein the instructions further cause the system to:
determine the action to be fine-tuning; and
trigger the fine-tuning of the machine learning model to adapt to the change in the dataset structure.

12. The system of claim 9, wherein the type is an output drift of the machine learning model determining relative to another machine learning model operating on the input data stream.

13. The system of claim 12, wherein the instructions further cause the system to:
determine the action to be adding an input prompt; and
trigger generation and addition of the input prompt.

14. The system of claim 9, wherein the input data stream comprises sampled operational data.

15. The system of claim 9, wherein the machine learning model is a large language model that generates a text summarization of log events.

16. The system of claim 9, where the machine learning model is a large language model that predicts a root cause of an event that causes a rollback to a prior state.

17. A method of large language model (LLM) optimization, comprising:
receiving output from the LLM generated in response to a sampled input stream of operational events, wherein the output of the LLM comprises a summary of log events after a rollback to a prior state;
determining output quality based on comparison to output from another LLM model;
detecting a drift in the output quality over time;
determining a type of drift; and
triggering performance of an action to at least mitigate the drift and improve output quality based on type.

18. The method of claim 17, further comprising:
determining a type of the drift to be a data drift resulting from a change in a dataset structure; and
triggering fine-tuning of the LLM to adapt to the change in the dataset structure.

19. The method of claim 17, further comprising:
determining the type to be an output drift, wherein the output of the LLM deviates relative to another LLM operating on the sampled input stream.
determining the action to be adding an input prompt; and
triggering generation and addition of the input prompt to user input to the LLM.

20. The method of claim 17, wherein the output of the LLM further comprises a root cause of the rollback.
